(19) United States
(12) Patent Application Publication
(10) Pub. No.: US 2013/0078504 A1
(43) Pub. Date: Mar. 28, 2013

(54) ACTIVE MATERIAL, METHOD OF MANUFACTURING THE SAME, NONAQUEOUS ELECTROLYTE BATTERY AND BATTERY PACK

(71) Applicants: Kazuhiro Yasuda, Yokohama-shi (JP); Takuya Iwasaki, Uenohara-shi (JP); Keigo Hoshina, Yokohama-shi (JP)

(72) Inventors: Kazuhiro Yasuda, Yokohama-shi (JP); Takuya Iwasaki, Uenohara-shi (JP); Keigo Hoshina, Yokohama-shi (JP)

(21) Appl. No.: 13/538,004

(22) Filed: Jun. 29, 2012

(30) Foreign Application Priority Data
Sep. 22, 2011 (JP) 2011-207097

(51) Int. Cl. H01M 4/13; C01G 33/00; C01G 23/04; H01M 2/02; B05D 3/02

(52) U.S. Cl. 429/163; 429/231.5; 427/215; 423/608; 423/598; 252/182.1

(57) ABSTRACT

According to one embodiment, there is provided an active material. The active material includes a titanate oxide compound. The active material has a peak appearing in a range of 1580 cm⁻¹ to 1610 cm⁻¹ in the infrared diffusion reflective spectrum when pyridine is absorbed onto the active material and released from it, after that, the active material is subjected to measurement of the infrared diffusion reflective spectrum. Further, a relationship represented by the following formula (I) is satisfied: S₁/S₂≧2.4 (I). Wherein S₁ indicates an area of a peak appearing in a range of 1430 cm⁻¹ to 1460 cm⁻¹ in the spectrum, and S₂ indicates an area of a peak appearing in a range of 1520 cm⁻¹ to 1560 cm⁻¹ in the spectrum.

### CROSS-REFERENCE TO RELATED APPLICATIONS

This application is based upon and claims the benefit of priority from prior Japanese Patent Application No. 2011-207097, filed Sep. 22, 2011, the entire contents of which are incorporated herein by reference.

### FIELD

Embodiments described herein relate generally to an active material, a method of manufacturing the same, a nonaqueous electrolyte battery, and a battery pack.

### BACKGROUND

The potential at which insertion of lithium ion occurs in a titanate oxide compound is higher than that in a carbonaceous material. Therefore, a nonaqueous electrolyte battery using the titanate oxide compound as a negative electrode active material has less possibility of the generation of lithium dendrites than that of a battery using the carbonaceous material. Further, the nonaqueous electrolyte battery using the titanate oxide compound has less possibility of the thermo runaway because the titanate oxide compound is a ceramic. Therefore, such a battery has a superior safety.

However, the titanate oxide compound has a comparatively high reactivity with the nonaqueous electrolyte. When the titanate oxide compound reacts with the nonaqueous electrolyte, the nonaqueous electrolyte may be decomposed. As a result, the impedance of a battery may be increased. Also, a gas may be generated and thereby expanding the battery. Thus, there is a problem that a cycle performance of the battery using the titanate oxide compound is liable to deteriorate.

### BRIEF DESCRIPTION OF THE DRAWINGS

FIG. 1 is a cross-sectional view of a nonaqueous electrolyte secondary battery according to a third embodiment;

FIG. 2 is an enlarged sectional view of a part A in FIG. 1;

FIG. 3 is an exploded perspective view of a battery pack according to a fourth embodiment;

FIG. 4 is a block diagram showing an electric circuit of the battery pack of FIG. 3; and

FIG. 5 shows IR spectra of batteries according to Examples and Comparative Example 1.

### DETAILED DESCRIPTION

In general, according to one embodiment, an active material comprising a titanate oxide compound is provided. The active material has a peak appearing in a range of 1580 cm⁻¹ to 1610 cm⁻¹ in the infrared diffusion reflective spectrum when pyridine is absorbed onto the active material and released from it, after that, the active material is subjected to measurement of the infrared diffusion reflective spectrum. Further, a relationship represented by the following formula (I) is satisfied:

S₁/S₂≧2.4 (I)

Wherein S₁ indicates an area of a peak appearing in a range of 1430 cm⁻¹ to 1460 cm⁻¹ in the spectrum, and S₂ indicates an area of a peak appearing in a range of 1520 cm⁻¹ to 1560 cm⁻¹ in the spectrum.

### First Embodiment

Hereinafter, an active material according to an embodiment will be described in detail. The active material is preferably used as an electrode active material of a battery, and is preferably used as a negative electrode active material.

The active material according to the embodiment comprises a titanate oxide compound. When pyridine is absorbed onto the active material and released from it, and then, the active material is subjected to measurement of the infrared diffusion reflective spectrum, the active material has a peak P₁ appearing in a range of 1430 cm⁻¹ to 1460 cm⁻¹, a peak P₂ appearing in a range of 1520 cm⁻¹ to 1560 cm⁻¹, and a peak P₃ appearing in a range of 1580 cm⁻¹ to 1610 cm⁻¹ in the spectrum. Here, an area of the peak P₁ is referred to as S₁, and an area of the peak P₂ is referred to as S₂. In the active material according to the embodiment, S₁/S₂ is 2.4 or more.

In the embodiment, a titanate oxide compound having a solid acid point and/or a hydroxyl group on its surface is used as the active material. Examples of such a titanate oxide compound include lithium titanate having a spinel structure and a compound having crystal structure of monoclinic titanium dioxide and represented by the general formula LiₓTiO₂. In the formula, x is varied by charging or discharging the battery, and satisfies a relationship represented by 0≦x≦1.

The Lewis acid point accepts a proton. On the other hand, the Broensted acid point donates a proton. The solid acid point such as a Lewis acid point and a Broensted acid point on the titanate oxide compound can be distinguished each other by measuring a spectrum according to a diffusion reflective spectral method using infrared rays. First, pyridine is absorbed onto the active material, and then, released from it. Then, the measurement is carried out with the active material after the treatment. Also, a peak derived from the hydrogen bonding of pyridine to the active material can be measured.

The peak P₁ is considered to be a peak combining a peak derived from the Lewis acid point and a peak derived from the hydrogen bonding of pyridine. The peak P₂ is considered to be a peak derived from the Broensted acid point. The peak P₃ is considered to be a peak derived from the hydrogen bonding of pyridine. The peak P₃ is not present in a general titanate oxide compound.

Although the measurement of the infrared diffusion reflective spectrum can be performed for the active material, it is preferably performed for the titanate oxide compound.

The titanate oxide compound having a solid acid point and a hydroxyl group or the like on its surface has high reactivity with a nonaqueous electrolyte. It is considered that the titanate oxide compound reacts with a solvent and a lithium salt contained in the nonaqueous electrolyte due to the Lewis acid point. Because of this, when a battery using the titanate oxide compound as the negative electrode active material is charged or discharged, an excess inorganic or organic coating film is formed on the negative electrode. Therefore, the resistance of the battery is increased, which reduces the output performance. This leads to deteriorated electrode performance, a rise in the internal resistance of the battery, and deterioration in the nonaqueous electrolyte. They cause a shortened cycle life of the battery.

The titanate oxide compound having a crystal structure of monoclinic titanium dioxide is a solid acid. Therefore, it has high reactivity with a nonaqueous electrolyte. The crystal structure of monoclinic titanium dioxide primarily belongs to the space group C2/m, showing a tunnel structure. Here, such a crystal structure is referred to as TiO₂(B) structure. The titanate oxide compound having such a structure is referred to as a titanate oxide compound having TiO₂(B) structure. Details of the TiO₂(B) structure are described in R. Marchand, L. Brohan, M. Tournoux, Material Research Bulletin 15, 1129 (1980). The titanate oxide compound having TiO₂(B) structure may be represented by the general formula LiₓTiO₂ (0≦x≦1). In the above formula, x is varied between 0 and 1 when the battery is charged or discharged.

The titanate oxide compound having TiO₂(B) structure has a high theoretical capacity. Therefore, the capacity of a battery can be increased by using such a titanate oxide compound as the active material. However, there is the problem that the cycle life of such a battery is remarkably shortened for the above reason.

In a battery using a carbonaceous material or lithium titanate having spinel structure as the negative electrode active material, a reaction between the negative electrode and the nonaqueous electrolyte can be limited by using the nonaqueous electrolyte containing vinylene carbonate. In such a battery, the vinylene carbonate is decomposed by reduction on the negative electrode to form a stable coating film on the negative electrode. Thereby, the excess formation of a coating film can be limited. However, in the battery using the titanate oxide compound having a solid acid point and a hydroxyl group or the like on its surface, such as the titanate oxide compound having TiO₂(B) structure, the reaction between the negative electrode and the nonaqueous electrolyte is not limited even if the nonaqueous electrolyte containing vinylene carbonate is used. Therefore, the formation of a coating film is continued. This causes an increase in resistance and reduction in a cycle life.

However, the active material having a peak P₃ and having an S₁/S₂ of 2.4 or more while it contains the titanate oxide compound is reduced in the influence of the Lewis acid point and hydroxyl group. Thereby, it is considered that the reactivity with the nonaqueous electrolyte is limited. Therefore, an increase in resistance of the battery can be limited and the cycle life of the battery can be improved by using such an active material.

It is considered that the Broensted acid point does not contribute much to the reaction with the nonaqueous electrolyte. Even when the influence of the Lewis acid point of the active material is reduced, or even when the hydrogen bonding of pyridine is generated, the influence of the Broensted acid point is not relatively reduced. Therefore, a ratio of the area S₁ of the peak P₁ derived from the Lewis acid point and the hydrogen bonding to the area S₂ of the peak P₂ derived from the Broensted acid point may be used as an indicator representing the influence of the Lewis acid point.

The active material according to this embodiment can be obtained by forming a metal oxide layer containing at least one element selected from Mg, Al, and Si on at least a part of a surface of a particle of titanate oxide compound. Alternatively, the active material can be obtained by attaching a compound having a hydrophilic group and a hydrophobic group such as a surfactant to at least a part of the surface of the titanate oxide compound particles.

A metal oxide containing Mg, Al, or Si is easily reacted with an OH group present on the surface of the titanate oxide compound by dehydration. The metal oxide layer is formed on at least a part of the surface of the titanate oxide compound particles by this reaction. The Lewis acid point present on the surface of the titanate oxide compound is covered with the metal oxide layer. Therefore, the influence of the Lewis acid point is reduced. As a result, the intensity of the peak appearing in a range of 1430 cm⁻¹ to 1460 cm⁻¹ and derived from the Lewis acid point is reduced.

When the metal oxide layer is presented, a new peak is generated in a range of 1430 cm⁻¹ to 1460 cm⁻¹. This peak is derived from the hydrogen bonding of pyridine to the surface of the metal oxide layer. Therefore, although the intensity of the peak derived from the Lewis acid point is reduced, the intensity of the peak P₁ appearing in this range is raised. This leads to an increase in an S₁ value and a rise in an S₁/S₂ value.

The metal oxide is intended to mean that it also includes a metal composite oxide. The whole surface of the titanate oxide compound particle is preferably covered with the metal oxide layer. Thereby, the influence of the Lewis acid point can be further reduced.

When the metal oxide layer is present on the surface of the titanate oxide compound, a peak P₃ derived from the hydrogen bonding of pyridine is generated. This peak P₃ is a peak which is not detected in a titanate oxide compound which does not have the above metal oxide layer.

A plurality of peaks having a wave number of about 1597 cm⁻¹, 1608 cm⁻¹, 1617 cm⁻¹, or 1633 cm⁻¹ appear in a range of 1580 cm⁻¹ to 1650 cm⁻¹ of the infrared diffusion reflective spectrum. The half value widths (FWHM) of these peaks are 30.8, 11, 11.4, and 13.6 respectively. The peak P₃ in this embodiment is obtained by combining two peaks having wave numbers of about 1597 cm⁻¹ and about 1608 cm⁻¹. The peak P₃ can be obtained by using software GRAMS/AI produced by Thermo Galactic Corporation, for example.

The active material preferably comprises the metal oxide in a ratio of 1% by mass or more and 20% by mass or less based on the total mass of the titanate oxide compound. The active material may comprise various titanate oxide compounds. Therefore, a value obtained by converting the titanate oxide compound as titanium dioxide is used for the total mass of the titanate oxide compound used in order to calculate the ratio of the metal oxide layer. Thereby, the amount of the metal oxide layer can be clearly defined by an analysis method to be described later.

When the metal oxide layer is present in a ratio of 1% by mass or more, a reaction between the titanate oxide compound and the nonaqueous electrolyte can be limited. When the metal oxide layer is present in a ratio of 20% by mass or less, reduction in a battery capacity can be limited. The metal oxide layer is more preferably presenter in a ratio of 1.5% by mass to 15% by mass based on the total mass of the titanate oxide compound, and is still more preferably present in a ratio of 2% by mass to 12% by mass.

The percentage by mass of the metal oxide layer contained in the active material can be calculated by using wet analysis using induction coupling plasma (ICP) emission analysis, and elemental analysis using a scanning electron microscope (SEM)-energy dispersive X-ray spectroscopy (EDX) in combination.

First, the active material is dissolved in an acid solvent to prepare a sample solution. This sample solution is subjected to the ICP emission analysis to analyze the total composition of the active material. Thereby, the amount of the metal oxide to the amount of titanium in the active material, specifically to the value converted as titanium dioxide, is obtained.

In the meantime, the active material is embedded in an epoxy resin or the like, and it is cut to produce a sample. This sample is observed by SEM-EDX to analyze the composition of the substance present on the surface of the titanate oxide compound, thereby confirming the metal oxide layer. Simultaneously, elemental analysis for the titanate oxide compound and the metal oxide layer is carried out by the attached EDX. It is preferably that the particle size distribution of the active material is investigated in advance by particle surface observation using SEM or by particle size distribution measurement, and then, the observation by SEM-EDX is carried out for the particles within the range of particle size distribution. Also, the observation by SEM-EDX is preferably carried out for the particles in which a section radius of the active material/a thickness of the metal oxide layer is the top 80% or more of all the measured particles in observation of a particle cutting plane using SEM.

From the results of the ICP analysis and the SEM-EDX measurement, the metal oxide is confirmed to be present in a layer state on the surface of the titanate oxide compound and not to be present as independent particles. Also, metal elements and oxygen are quantitatively analyzed. Therefore, the percent by mass of the metal oxide to the mass of the titanate oxide compound can be calculated.

When the active material is taken out from the negative electrode in the battery and is subjected to analysis, the negative electrode active material layer, to be described later, is taken out from the negative electrode. A part of the negative electrode active material layer is subjected to a Soxhlet extraction method and a heat treatment to remove other components such as a polymer material and a conductive agent to obtain the active material.

In the active material of this embodiment, the titanate oxide compound is preferably a titanate oxide compound having TiO₂(B) structure. As described above, the titanate oxide compound having TiO₂(B) structure has high reactivity with the nonaqueous electrolyte. Therefore, this embodiment is more effectively applied.

The titanate oxide compound having TiO₂(B) structure may contain a hetero element. The hetero element may be at least one element selected from Zr, Nb, Mo, Ta, Y, P, and B. When the hetero element is contained, the influence of a Lewis acid point on the surface of the titanate oxide compound is limited. The hetero element is preferably contained in an amount range from 0.01% by mass to 8% by mass based on the mass of the titanate oxide compound containing the hetero element. When the hetero element is contained in an amount of 0.01% by mass or more, the influence of the Lewis acid point can be reduced. The hetero element is preferably contained in an amount of 8% by mass or less from the viewpoint of the solid-solubility limit of the hetero element. The hetero element is more preferably contained in an amount of 0.05% by mass to 3% by mass. The content of the hetero element in the titanate oxide compound containing the hetero element can be measured by the induction coupling plasma (ICP) emission spectral analysis method.

### (Diffusion Reflective Spectral Method Using Infrared Rays)

The method of measuring an infrared diffusion reflective spectrum will be described.

First, an active material which is subjected to measurement is put in a sample cup, which is then set in the cell of a diffusion reflectometer. The inside of the cell is heated to 500° C. and kept at that temperature for 1 hour while flowing nitrogen gas at a rate of 50 mL/min. Then, the temperature is dropped to ambient temperature and then raised again to 100° C. Then, the pressure in the cell in which the sample cup is placed is reduced, pyridine vapor is introduced into the cell and adsorbed onto the active material for 30 minutes.

Then, the temperature is kept at 100° C. for 1 hour while flowing nitrogen gas at a rate of 100 mL/min and then, raised to 150° C. and kept for 1 hour. Pyridine which is physically adsorbed to or hydrogen-bonded with the active material is released by this treatment. Then, the infrared diffusion reflective spectrum of the sample is measured.

In the obtained spectrum, the peak area is found by eliminating the background and drawing a base line between both ends of the peak.

According to such diffusion reflective spectral method using infrared rays, functional groups present in the sample are identified and therefore, the constitution of the measured sample can be clarified.

When the active material comprised in the electrode is measured, the active material is extracted from the electrode and subjected to measurement. For example, a layer comprising the active material is peeled from the current collector. Then, the active material is extracted from the layer by extraction and heat treatment of the layer to remove a polymer material and a conductive agent, or the like. As an example, a layer comprising the active material may be peeled from the current collector and then, a polymer material is removed by the Soxhlet extraction method, making it possible to extract the active material and carbon material. In the Soxhlet extraction method, N-methylpyrrolidone (NMP) may be used as the solvent, thereby removing the polymer material from the electrode. In a mixture of the active material and carbon material obtained by the Soxhlet extraction method, the carbon material may be oxidized by oxygen and ozone or the like to remove it in the form of carbon dioxide, thereby extracting only the active material.

### (Specific Surface Area)

The specific surface area of the titanate oxide compound is preferably in the range from 5 m²/g to 100 m²/g. When the specific surface area is 5 m²/g or more, the sites for insertion of lithium ion are sufficiently secured, thereby improving a capacity of a battery. When the specific surface area is 100 m²/g or less, the coulomb efficiency in charge-discharge operations is improved.

According to the embodiment, the active material which can realize a nonaqueous electrolyte battery limited in the increase in resistance and improved in a cycle life can be provide.

### Second Embodiment

Next, the method of producing the active material according to the first embodiment will be described. In this embodiment, a metal oxide layer containing at least one element selected from Mg, Al, and Si is formed on at least a part of a surface of titanate oxide compound particles. Thereby, the surface physical properties of a titanate oxide compound can be changed. As a result, an active material having a peak P₃ appearing in a range of 1580 cm⁻¹ to 1610 cm⁻¹ and having an S₁/S₂ of 2.4 or more in the infrared diffusion reflective spectrum of the active material after pyridine is absorbed and released can be produced.

Examples of the method of forming the metal oxide layer include the following two methods.

### (First Method)

A first method includes: mixing the titanate oxide compound particles with a metal alkoxide containing at least one element selected from Mg, Al, and Si and water to obtain a mixture; and drying the mixture to form a metal oxide layer containing at least one element selected from Mg, Al, and Si on at least a part of a surface of the titanate oxide compound particles.

The titanate oxide compound particles are mixed with the metal alkoxide containing at least one element selected from Mg, Al, and Si and an appropriate amount of water. Thereby, a metal oxide precursor can be formed on the surface of the titanate oxide compound particles. Then, the particles are subjected to a drying treatment. Thereby, the metal oxide precursor can be polymerized to form the metal oxide layer. Such a method is referred to as a sol gel method.

The drying treatment is preferably carried out at a temperature of 50 to 250° C. When a drying temperature is too high, water and organic matter in the metal oxide precursor are evaporated. As a result, the metal oxide layer may not be uniformly formed and may be formed patchily on the surface of the titanate oxide compound particle. Therefore, the drying treatment is preferably carried out at 250° C. or less, and more preferably at 50 to 100° C.

The percentage by mass of the metal oxide layer comprised in the active material can be adjusted by changing an amount of a metal alkoxide to be added, an amount of water to be added, or a drying condition.

Such a sol gel method is particularly suitable when the titanate oxide compound having TiO₂(B) structure is treated. Advantageously, it is not necessary to use a catalyst because the catalytic action of the titanate oxide compound having TiO₂(B) structure can promote the polymerization reaction of an alkoxide.

### (Second Method)

A second method includes: mixing the titanate oxide compound particles with an aqueous solution to obtain a mixture, the solution containing a compound selected from hydroxide and chloride, the compound containing at least one element selected from Mg, Al, and Si; attaching a metal oxide precursor containing at least one element selected from Mg, Al, and Si on at least a part of a surface of the titanate oxide compound particles by adjusting the pH of the mixture to 10 to 14; separating the titanate oxide compound particles with the metal oxide precursor attached on the surface from the aqueous solution; and drying the separated titanate oxide compound particles to form a metal oxide layer containing at least one element selected from Mg, Al, and Si on at least a part of a surface of the titanate oxide compound particles.

First, the titanate oxide compound particles are mixed with an aqueous solution containing a compound containing at least one element selected from Mg, Al, and Si, to obtain a mixed solution. The compound is selected from hydroxide and chloride. Then, the pH of this mixed solution is adjusted to 10 to 14. Thereby, the hydroxide or the chloride is converted into the metal oxide precursor, which is attached to the surface of the titanate oxide compound particles. Then, the titanate oxide compound particles with the metal oxide precursor adhered on the surface are obtained by separating the particles from the mixed solution. Then, the particles are dried to polymerize the metal oxide precursor, thereby forming the metal oxide layer. Such a method is referred to as an aqueous solution pH adjusting method. In the aqueous solution pH adjusting method, metal hydroxide or metal chloride is first hydrated. The hydrate is attached to the titanate oxide compound particles. The metal oxide layer can be then formed by polymerizing the hydrate under a dehydration reaction.

The drying is preferably carried out at a temperature of 20 to 250° C. The drying is more preferably carried out at ambient temperature sufficiently, and then carried out at high temperatures. When the drying is carried out at high temperatures from the start, water is rapidly evaporated. As a result, the metal oxide layer may not be uniformly formed and may be formed patchily on the surface of the titanate oxide compound particle. More preferably, primary drying is carried out in a temperature range of 20 to 60° C. for 1 to 20 hours, and secondary drying is then carried out in a temperature range of 100 to 125° C. for 30 minutes to 2 hours.

The percentage by mass of the metal oxide layer comprised in the active material can be attached by changing an amount of the hydroxide or chloride to be first added and a pH value.

According to the first and second methods described above, the metal oxide layer can be formed on at least a part of the surface of the titanate oxide compound. As a result, the titanate oxide compound having a peak P₃ and having an S₁/S₂ of 2.4 or more in the infrared diffusion reflective spectrum of the active material after pyridine is absorbed and released can be produced.

(Method of Synthesizing Titanate oxide compound Having TiO₂(B) Structure)

The titanate oxide compound used in this embodiment may be synthesized using raw materials, or may be available commercially. Hereinafter, a method of synthesizing the titanate oxide compound having TiO₂(B) structure will be described as a synthetic example of the titanate oxide compound.

The method of synthesizing a titanate oxide compound having a TiO₂ (B) structure comprises: synthesizing an alkali titanate oxide compound by mixing a compound containing Ti and a compound containing an alkali element and heating; obtaining a proton-exchanged compound by reacting the alkali titanate oxide compound with an acid to exchange the alkali cation for a proton; and heating the proton-exchanged compound at least two times.

First, a compound containing Ti and a compound containing an alkali element are used as starting materials. These starting materials are mixed in a predetermined stoichiometric ratio and the mixture is heated to synthesize an alkali titanate oxide compound. The crystal of the alkali titanate oxide compound synthesized here may have any form. The heat treatment may be carried out at 800 to 1100° C.

As the compound containing Ti among the starting materials, one or more compounds selected from TiO₂ having an anatase structure and TiO₂ having a rutile structure and TiCl₄ may be used. As the compound containing an alkali element, a compound containing Na, K or Cs may be used. The compound may be selected from carbonates, hydroxides and chlorides.

Next, proton exchange is carried out by an acid treatment. First, an alkali titanate oxide compound is washed with distilled water to remove impurities. After that, the alkali titanate oxide compound is acid-treated to exchange the alkali cation of the alkali titanate oxide compound for a proton, thereby obtaining a proton-exchanged compound. As to alkali titanate oxide compounds such as sodium titanate, potassium titanate, and cesium titanate, their alkali cations can be exchanged for protons without destructing the crystal structure.

The acid treatment may be carried out by mixing the alkali titanate oxide compound particles and an acid, followed by stirring. An acid selected from hydrochloric acid, nitric acid, and sulfuric acid may be used in a concentration of 0.5 to 2 M. The acid treatment is preferably continued until the alkali cations are sufficiently exchanged for protons. The acid treatment is carried out preferably for 24 hours or more and more preferably for 1 to 2 weeks at an ambient temperature of about 25° C. though the time is not particularly limited. Further, the acid solution is preferably exchanged for a fresh one every 24 hours. The acid treatment may be carried out, for example, using 1 M sulfuric acid under the ambient temperature for 24 hours.

For example, the proton exchange can be performed more smoothly by carrying out an acid treatment while applying a vibration such as ultrasonic vibration. Thereby, a proton-exchanged compound in a more suitable state can be obtained.

It is also preferable to mill the alkali titanate oxide compound in advance by using a ball mill or the like to enable a more efficient proton exchange. The milling may be carried out using zirconia balls having a diameter of about 10 to 15 mm in a 100 cm² container which is rotated at 600 to 1000 rpm for about 1 to 3 hours. The alkali titanate oxide compound can be sufficiently milled by carrying out milling for 1 hour or more. When the milling time is designed to be 3 hours or less, such a phenomenon that compounds different from a target product are generated by a mechanochemical reaction can be prevented.

After the proton exchange is finished, an alkaline solution such as an aqueous lithium hydroxide solution is optionally added to neutralize the residual acid. The obtained proton-exchanged compound is washed with distilled water and then dried. It is preferable to sufficiently wash the proton-exchanged compound until the pH of the washed water falls into a range from 6 to 8. In the meantime, the process is allowed to proceed to the next step without the neutralization of the residual acid after the acid treatment, and without washing and drying.

Then, the proton-exchanged compound is heat-treated at least two times. A first heat treatment is carried out in a temperature range from 350 to 500° C. for 1 to 3 hours. Then, the obtained titanate oxide compound is subjected to a second heat treatment. The second heat treatment is carried out in a temperature range from 200 to 300° C. for 1 to 24 hours. Further heat treatments may be repeated in a temperature range from 200 to 300° C.

The titanate oxide compound having TiO₂(B) structure can be synthesized by the above method. The titanate oxide compound having TiO₂(B) structure obtained by the method may contain Li in advance by using a compound containing Li as the starting material. Alternatively, it may be one into which Li is inserted by charge-discharge operations.

Whether the titanate oxide compound has TiO₂(B) structure or not can be identified by powder X-ray diffraction using Cu—Kα as ray source. The powder X-ray diffraction measurement can be performed in the following manner. First, a target sample is ground until the average particle diameter reaches about 5 μm. The average particle diameter can be found by the laser diffraction method. The ground sample is filled in a holder part which is formed on a glass sample plate and has a depth of 0.2 mm. At this time, much care is necessary to fill the holder part fully with the sample. Further, special care should be taken to avoid cracking and formation of voids caused by insufficient filling of the sample. Then, a separate glass plate is used to smooth the surface of the sample by sufficiently pressing the separate glass plate against the sample. Much care should be taken to avoid too much or too little amount of the sample to be filled, thereby preventing any rises and dents in the basic plane of the glass holder.

Then, the glass plate filled with the sample is set to a powder X-ray diffractometer. The measurement is carried out by using Cu—Kα rays to obtain a XRD pattern. In generally, TiO₂(B) has low crystallinity. Thus, some samples have weak peak intensities in X-ray diffraction and have peak of which intensity is hard to observe. Because the metal oxide layer has low crystallinity and the content thereof is also low, the metal oxide layer hardly influences the diffraction spectrum of the titanate oxide compound obtained by a powder X-ray diffraction method.

### (Method of Synthesizing Titanate Oxide Compound Containing Hetero Element and Having TiO₂(B) Structure)

Next, a method of synthesizing a titanate oxide compound containing a hetero element and having TiO₂(B) structure will be described.

The method comprises: synthesizing an alkali titanate oxide compound containing a hetero element by mixing a compound containing Ti, a compound containing an alkali element and a compound containing a hetero element and heating; obtaining a proton-exchanged compound containing a hetero element by reacting the alkali titanate oxide compound containing a hetero element with an acid to exchange the alkali cation for a proton; and producing a titanate oxide compound having TiO₂(B) structure and containing a hetero element by heating the proton-exchanged compound containing a hetero element.

First, a compound containing Ti, a compound containing an alkali element, and a compound containing a hetero element are used as starting materials. These starting materials are mixed in a predetermined stoichiometric ratio and heated to synthesize an alkali titanate oxide compound containing a hetero element. The alkali titanate oxide compound synthesized here may have any crystal form. The heat treatment may be carried out at, though not limited to, 800 to 1100° C.

As the compound containing Ti and the compound containing an alkali element among the starting materials, those described in the above first method may be used.

As the compound containing a hetero element, a compound containing at least one element selected from Zr, Nb, Mo, Ta, Y, P, and B may be used. The compound may be one or more compounds selected from carbonates and hydroxides or the like.

Examples of the alkali titanate oxide compound containing a hetero element include, though are not limited to, sodium titanate, potassium titanate, and cesium titanate.

Next, proton exchange is performed by an acid treatment. First, an alkali titanate oxide compound containing a hetero element is sufficiently washed with distilled water to remove impurities. After that, the alkali titanate oxide compound is acid-treated to exchange the alkali cation of the alkali titanate oxide compound for a proton, thereby obtaining a proton-exchanged compound containing a hetero element. As to alkali titanate oxide compounds such as sodium titanate, potassium titanate, and cesium titanate, their alkali cations can be exchanged for protons without destructing the crystal structure, and this is the same for the alkali titanate oxide compounds containing a hetero element.

The acid treatment may be carried out by adding an acid to the alkali titanate oxide compound particles, followed by stirring. An acid selected from hydrochloric acid, nitric acid, and sulfuric acid may be used in a concentration of 0.5 to 2 M. The acid treatment is preferably continued until the alkali cations are exchanged sufficiently for protons. The acid treatment is carried out preferably for 24 hours or more and more preferably for 1 to 2 weeks when the acid treatment is carried out at an ambient temperature of about 25° C. by using hydrochloric acid having a concentration of about 1 M, though the time is not particularly limited. Further, the acid solution is preferably exchanged for a fresh one every 24 hours. As described in the first method, the acid treatment may be carried out while applying a vibration such as ultrasonic vibration. The alkali titanate oxide compound may be preferably milled in advance by a ball mill or the like to perform the proton exchange more efficiently.

After the proton exchange is finished, an alkaline solution such as an aqueous lithium hydroxide solution is optionally added to neutralize the residual acid. The obtained proton-exchanged compound containing a hetero element is washed with distilled water and then dried. It is preferable to sufficiently wash the proton-exchanged compound until the pH of the washed water falls into a range from 6 to 8. In the meantime, the process is allowed to proceed to the next step without the neutralization of the residual acid after the acid treatment, and without washing and drying.

Then, the proton-exchanged compound containing a hetero element is heated to obtain a titanate oxide compound containing a hetero element and having TiO₂(B) structure.

The heating temperature is preferably in a range from 250 to 500° C. though it is determined properly depending on the proton-exchanged compound because the optimal temperature differs depending on the conditions such as the composition, particle size and crystal form of the proton-exchanged compound. When the heating temperature is 250° C. or more, the proton-exchanged compound has high crystallinity, and the generation of an impurity phase such as H₂Ti₈O₁₇ is limited. Thereby, an electrode capacity, charge-discharge efficiency and repetitive performance are superior. When the heating temperature is 500° C. or less, the generation of impurity phases such as H₂Ti₈O₁₇ and TiO₂ having an anatase structure is limited. Therefore, a reduction in an electrode capacity can be prevented. The heating temperature is more preferably 300 to 400° C.

The heating time may be set in a range from 30 minutes or more and 24 hours or less corresponding to the temperature. When the heating temperature is, for example, 300° C. or more and 400° C. or less, the heating time may be designed to be for 1 hour or more and 3 hours or less.

A titanate oxide compound containing a hetero element and having TiO₂(B) structure can be synthesized by the above method. Lithium may be contained in the titanate oxide compound having TiO₂(B) structure obtained by such a method in advance by using a compound containing lithium as the starting material. Alternatively, it may be one which absorbs lithium by charge or discharge operations.

According to the above embodiment, the active material containing the titanate oxide compound having a peak P₃ and having an S₁/S₂ of 2.4 or more in the infrared diffusion reflective spectrum of the active material after pyridine is absorbed and released can be produced. A nonaqueous electrolyte battery suppressed in the increase in resistance and improved in a cycle life can be realized by using such an active material.

### Third Embodiment

According to a third embodiment, a nonaqueous electrolyte battery is provided. A nonaqueous electrolyte battery comprises a positive electrode, a negative electrode, and a nonaqueous electrolyte.

The positive electrode comprises a positive electrode current collector and a positive electrode layer (i.e., layer containing positive electrode active material). The positive electrode layer comprises a positive electrode active material, a conductive agent, and a binder. The positive electrode layer is provided on one or both surfaces of the positive electrode current collector.

The negative electrode comprises a negative electrode current collector and a negative electrode layer (i.e., layer containing negative electrode active material). The negative electrode layer comprises the first negative electrode active material, the second negative electrode active material, the conductive agent, and the binder. The negative electrode layer is provided on one or both surfaces of the negative electrode current collector.

Hereinafter, the nonaqueous electrolyte secondary battery of this embodiment will be described with reference to the drawings. The same reference numerals denote common portions throughout the embodiments and an overlapped description is not repeated. Each drawing is a pattern diagram to facilitate the description of the embodiments and its understanding. The shape, size, and ratio thereof are different from those of an actual device. However, they can be appropriately designed and modified by taking into consideration the following description and known techniques.

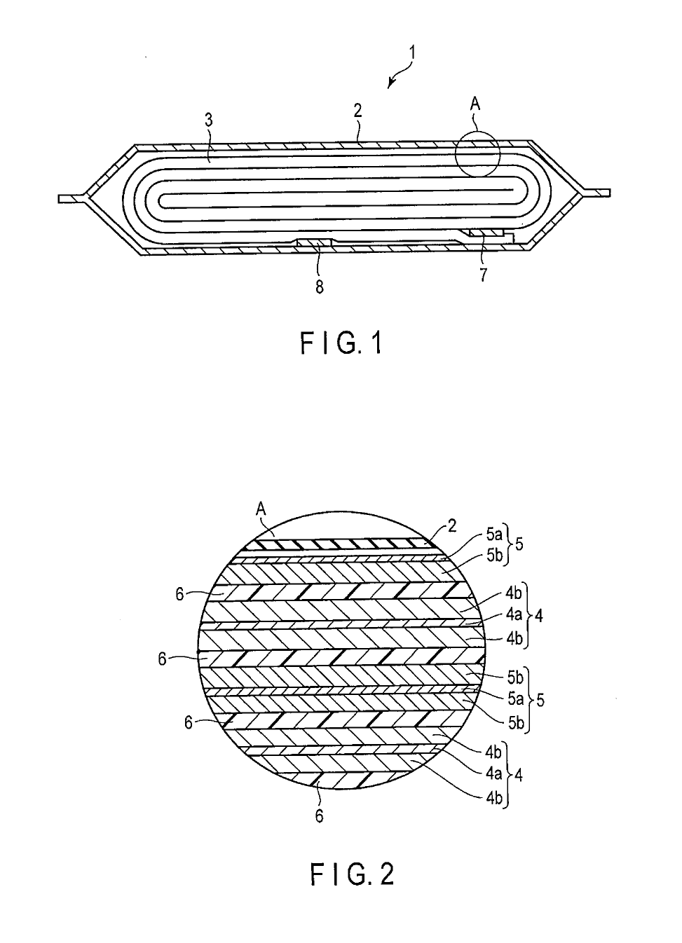

FIG. 1 shows an example of the nonaqueous electrolyte battery according to this embodiment. FIG. 2 is a cross-sectional diagram of a flat-type nonaqueous electrolyte secondary battery. FIG. 2 is an enlarged sectional view of a portion A in FIG. 1. A battery 1 comprises a container 2, a wound electrode group 3 with a flat shape, a positive electrode terminal 7, a negative electrode terminal 8, and a nonaqueous electrolyte.

The container 2 has a baggy shape. The container 2 is made of a laminate film. The wound electrode group 3 is accommodated in the container 2. The wound electrode group 3 comprises a positive electrode 4, a negative electrode 5, and a separator 6 as shown in FIG. 2. The wound electrode group 3 is formed by spirally winding a laminated product obtained by laminating the negative electrode 5, the separator 6, the positive electrode 4, and the separator 6 in this order from the outside and press molding the resultant product.

The positive electrode 4 comprises a positive electrode current collector 4a and a positive electrode layer 4b. The positive electrode layer 4b comprises the positive electrode active material. The positive electrode layer 4b is provided on each surface of the positive electrode current collector 4a.

The positive electrode layer is provided on both surfaces of the positive electrode current collector 4a.

As the positive electrode active material, for example, oxides or polymers may be used.

Examples of the oxides include compounds into which lithium ion can be inserted, for example, manganese dioxide (Mno₂), iron oxide, copper oxide and nickel oxide, lithium-manganese complex oxide (for example, LiₓMn₂O₄ or LiₓMnO₂), lithium-nickel complex oxide (for example, LiₓNiO₂), lithium-cobalt complex oxide (for example, LiₓCoO₂), lithium-nickel-cobalt complex oxide (for example, LiNi_{1-y}Co_{y}O₂), lithium-manganese-cobalt complex oxide (for example, LixMn_{y}Co_{1-y}O₂), lithium-nickel-cobalt-manganese complex oxide (for example, LiNi_{1-y-z}Co_{y}Mn_{z}O₂), lithium-nickel-cobalt-aluminum complex oxide (for example, LiNi_{1-y-z}Co_{y}Al_{z}O₂), lithium-manganese-nickel complex oxide having spinel structure (for example, LiₓMn_{2-y}Ni_{y}O₄), lithium phosphate having olivine structure (for example, LiₓFePO₄, LiₓFe_{1-y}Mn_{y}PO₄, and LiₓCoPO₄), iron sulfate (Fe₂(SO₄)₃) and vanadium oxide (for example, V₂O₅). Here, x, y, and z preferably satisfy the following formulae: 0<x≦1, 0≦y≦1, and 0≦z≦1, respectively.

The above-described compounds can be used alone or in combinations of two or more.

Examples of the polymers include conductive polymer materials such as pol-yaniline or polypyrrole and disulfide type polymer materials.

Sulfur (S) or carbon fluoride may be used as the active material.

More preferable examples of the positive-electrode active material include oxides having a high positive electrode voltage, for example, lithium-manganese complex oxide (for example, LiₓMn₂O₄), lithium-manganese-nickel complex oxides having spinel structure (for example, LiₓMn_{2-y}Ni_{y}O₄), lithium-nickel complex oxide (for example, LiₓNiO₂), lithium-cobalt complex oxide (for example, LiₓCoO₂), lithium-nickel-cobalt complex oxide (for example, LiₓNi_{1-y}Co_{y}O₂), lithium-manganese-cobalt complex oxide (for example, LiₓMn_{y}Co_{1-y}O₂), lithium-nickel-cobalt-manganese complex oxide (for example, LiNi_{1-y-z}Co_{y}Mn_{z}O₂) and lithium iron phosphate (for example, LiₓFePO₄). Here, x, y, and z preferably satisfy the following formulae: 0<x≦1, 0≦y≦1, and 0≦z≦1, respectively.

The conductive agent is used to improve the current collection performance and suppress the contact resistance between the active material and the current collector. Examples of the conductive agent include carbonaceous materials such as acetylene black, carbon black, graphite, a carbon nanofiber, or a carbon nanotube.

The binder is used to bind the active material, the conductive agent, and the current collector with each other. Examples of the binder include polytetrafluoroethylene (PTFE), polyvinylidene fluoride (PVdF), and fluorine-based rubber.

The active material, conductive agent and binder in the positive electrode layer are preferably formulated in ratios of 80% by mass or more and 95% by mass or less, 3% by mass or more and 18% by mass or less, and 2% or more and 17% by mass or less respectively.

When the content of the conductive agent is 3% by mass or more, the above effects can be exerted. When the content is 18% by mass or less, decomposition of the nonaqueous electrolyte on the surface of the conductive agent under high temperature storage can be reduced.

When the content of the binder is 2% by mass or more, sufficient electrode strength is obtained. When the content is 17% by mass or less, the blending amount of the insulator of the electrode can be decreased and the internal resistance can be reduced.

The current collector is preferably made of an aluminum foil or aluminum alloy foil containing at least one element selected from Mg, Ti, Zn, Mn, Fe, Cu and Si.

The positive electrode can be produced by, for example, the following method. First, a positive electrode active material, a conductive agent, and a binder are suspended in a solvent to prepare slurry. The slurry is applied to one or both surfaces of a positive electrode current collector, followed by drying to form a positive electrode layer. Thereafter, the resultant layer is pressed. Alternatively, a pellet is formed from the positive electrode active material, the conductive agent, and the binder. The pellet is used as the positive electrode layer.

The negative electrode 5 comprises a negative electrode current collector 5a and a negative electrode layer 5b. The negative electrode layer 5b comprises a negative electrode active material. In the outermost negative electrode 5, the negative electrode layer 5b is provided on only the inner surface of the negative electrode current collector 5a. In other portions, the negative electrode layer 5b is provided on both surfaces of the negative electrode current collector 5a.

The negative electrode active material comprises the active material according to the first embodiment. Thereby, the increase in resistance can be limited, and as a result, the cycle life of the nonaqueous electrolyte battery can be improved.

The negative electrode active material may contain only the active material according to the first embodiment, but the negative electrode active material may contain other compound. The other compound is preferably contained in a ratio of 50% by mass or less of the total mass of the active material. Examples of the other compound include graphite, hard carbon, silicon and germanium.

The conductive agent is used to improve the current collection performance and suppress the contact resistance between the active material and the current collector. Examples of the conductive agent include carbonaceous materials such as acetylene black, carbon black, graphite, a carbon nano fiber, or a carbon nanotube.

The binder is used to bind the active material, the conductive agent, and the current collector with each other. Examples of the binder include polytetrafluoroethylene (PTFE), polyvinylidene fluoride (PVdF), fluorine-based rubber and styrene-butadiene rubber.

The active material, conductive agent, and binder in the negative electrode layer are preferably formulated in ratios of 70% by mass or more and 96% by mass or less, 2% by mass or more and 28% by mass or less, and 2% by mass or more and 28% by mass or less respectively.

When the content of the conductive agent is 2% by mass or more, the current collecting performance of the negative electrode layer can be improved. When the content of the binder is 2% by mass or more, the binding strength between the negative electrode layer and the current collector can be improved. On the other hand, the contents of the conductive agent and binder are respectively preferably 28% by mass or less from the viewpoint of improvement in capacity.

The current collector is preferably made of an aluminum foil, or an aluminum alloy foil containing elements such as Mg, Ti, Zn, Mn, Fe, Cu, or Si, which is electrochemically stable in a potential range higher than 1.0 V (vs Li/Li⁺). Here, “V (vs Li/Li⁺)” is mean to a potential relative to metallic lithium.

The negative electrode can be produced by, for example, the following method. First, a negative electrode active material, a conductive agent, and a binder are suspended in a solvent to prepare a slurry. The slurry is applied to one or both surfaces of a negative electrode current collector, followed by drying to form a negative electrode layer. Thereafter, the resultant layer is pressed. Alternatively, a pellet is formed from the negative electrode active material, the conductive agent, and the binder. The pellet is used as the negative electrode layer.

As the separator, a porous film made from materials such as polyethylene, polypropylene, cellulose, or polyvinylidene fluoride (PVdF), a synthetic resin nonwoven fabric or the like can be used. A porous film made of polyethylene or polypropylene melts at a certain temperature and can block electric current, and thus it is preferred from the viewpoint of improvement in safety.

As shown in FIG. 1, near the peripheral edge of the wound electrode group 3, the band-shaped positive electrode terminal 7 is connected to the positive electrode current collector 4a. The band-shaped negative electrode terminal 8 is connected to the negative electrode current collector 5a at the outermost layer of the wound electrode group. The positive electrode terminal 7 and the negative electrode terminal 8 are extended outside through an opening of the container 2. Further, the nonaqueous electrolyte is injected into the container 2. The opening of the container 2 is heat-sealed in a state that the positive electrode terminal 7 and the negative electrode terminal 8 are sandwiched, thereby the wound electrode group 3 and the nonaqueous electrolyte are completely sealed.

As the nonaqueous electrolyte, a liquid nonaqueous electrolyte or gel-like nonaqueous electrolyte can be used. The liquid nonaqueous electrolyte can be prepared by dissolving an electrolyte in an organic solvent. The concentration of the electrolyte in the liquid nonaqueous electrolyte is preferably from 0.5 mol/L to 2.5 mol/L. The gel-like nonaqueous electrolyte can be prepared by forming a composite of a liquid electrolyte and a polymer material.

Examples of the electrolyte include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethasulfonate (LiCF₃SO₃), and bistrifluoromethylsulfonylimide lithium [LiN(CF₃SO₂)₂], and mixtures thereof. The electrolyte is preferably one which is scarcely oxidized at a high potential and LiPF₆ is most preferable.

Examples of the organic solvent include cyclic carbonates such as propylene carbonate (PC), ethylene carbonate (EC) or vinylene carbonate; chain carbonates such as diethyl carbonate (DEC), dimethyl carbonate (DMC) or methylethyl carbonate (MEC); cyclic ethers such as tetrahydrofuran (THF), 2-methyltetrahydrofuran (2MeTHF) or dioxolan (DOX); chain ethers such as dimethoxyethane (DME) or diethoxyethane (DEE); or γ-butyrolactone (GBL), acetonitrile (AN) and sulfolan (SL). These organic solvents may be used either singly or in combinations of two or more.

More preferable examples of the organic solvent include mixture solvents containing two or more solvents selected from the group consisting of propylene carbonate (PC), ethylene carbonate (EC), diethyl carbonate (DEC), dimethyl carbonate (DMC) and methylethyl carbonate (MEC), and mixture solvents containing γ-butyrolactone (GBL). A nonaqueous electrolyte battery having excellent low-temperature characteristics can be obtained by using such mixture solvents.

Examples of the polymer material include polyvinylidene fluoride (PVdF), polyacrylonitrile (PAN) and polyethylene oxide (PEO).

As the container, a baggy container formed of a laminate film or a metal container is used.

Examples of the shape of the container include a flat type (thin type), angular type, cylinder type, coin type, button type, sheet-type, and lamination-type shapes. The container having a size corresponding to the dimensions of a battery are used. For example, containers for small-sized batteries to be mounted on portable electronic devices and containers for large-sized batteries to be mounted on, for example, two- to four-wheel vehicles are also used.

As the laminate film, a multilayer film prepared by interposing a metal layer between resin layers may be used. The metal layer is preferably formed of an aluminum foil or aluminum alloy foil to reduce the mass of the battery. For example, polymer materials such as polypropylene (PP), polyethylene (PE), nylon or polyethylene terephthalate (PET) may be used for the resin layer. The laminate film can be molded into a desired shape by sealing through thermal fusion. The thickness of the laminate film is preferably 0.2 mm or less.

The metal container may be made of aluminum, an aluminum alloy or the like. The aluminum alloy is preferably an alloy containing one or more elements selected from Mg, Zn, or Si. When the alloy contains transition metals such as Fe, Cu, Ni or Cr, the amount of the transition metals is preferably 1% by mass or less. Thus, the long-term reliability under the high temperature and heat releasing property can be dramatically improved. The metal container preferably has a thickness of 0.5 mm or less, more preferably 0.2 mm or less.

The positive electrode terminal 7 is made of, for example, a material having electric stability and conductivity in a potential range from, preferably, 3 to 5 V (vs Li/Li⁺). Specific examples of these materials include aluminum and aluminum alloys containing elements such as Mg, Ti, Zn, Mn, Fe, Cu or Si. The positive electrode terminal is preferably made of the same material as the positive electrode current collector to reduce the contact resistance with the positive electrode current collector.

The negative electrode terminal 8 is made of, for example, a material having electric stability and conductivity in a potential range of 0.3 to 3 V (vs Li/Li⁺). Specifically, examples of these materials include aluminum and aluminum alloys containing elements such as Mg, Ti, Zn, Mn, Fe, Cu, or Si. The negative electrode terminal is preferably made of the same material as the negative electrode current collector to reduce the contact resistance with the negative electrode current collector.

According to the above embodiment, a nonaqueous electrolyte battery which is suppressed in the increase in resistance and improved in a cycle life can be provided.

### Fourth Embodiment

Subsequently, a battery pack according to a fourth embodiment will be explained with reference to the drawings. The battery pack comprises one or two or more of the above nonaqueous electrolyte batteries (unit cells) according to the third embodiment. When the battery pack includes two or more unit cells, these unit cells are disposed in such a manner that they are electrically connected in series or in parallel.

FIG. 6 and FIG. 7 show an example of a battery pack 20. This battery pack 20 comprises two or more flat-type unit cells 21. FIG. 6 is an exploded perspective view of the battery pack 20. FIG. 7 is a block pattern showing the electric circuit of the battery pack 20 shown in FIG. 6.

A plurality of unit cells 21 are laminated such that the externally extended positive electrode terminal 18 and negative electrode terminal 19 are arranged in the same direction and fastened with an adhesive tape 22 to thereby constitute a battery module 23. These unit cells 21 are electrically connected in series as shown in FIG. 7.

A printed wiring board 24 is disposed opposite to the side surface of the unit cell 21 from which the positive electrode terminal 18 and negative electrode terminal 19 are extended. As shown in FIG. 7, a thermistor 25, a protective circuit 26 and an energizing terminal 27 connected to external devices are mounted on the printed wiring board 24. An insulating plate (not shown) is attached to the surface of the printed wiring board 24 facing the battery module 23 to avoid unnecessary connection with the wiring of the battery module 23.

A positive electrode side lead 28 is connected to the positive electrode terminal 18 positioned on the lowermost layer of the battery module 23 and one end of the positive electrode side lead 28 is inserted into and electrically connected to a positive electrode side connector 29 of the printed wiring board 24. A negative electrode side lead 30 is connected to the negative electrode terminal 19 positioned on the uppermost layer of the battery module 23 and one end of the negative electrode side lead 30 is inserted into and electrically connected to a negative electrode side connector 31 of the printed wiring board 24. These connectors 29 and 31 are connected to the protective circuit 26 through wirings 32 and 33 formed on the printed wiring board 24.

The thermistor 25 is used to detect the temperature of the unit cell 21 and the detected signals are transmitted to the protective circuit 26. The protective circuit 26 can shut off a plus side wiring 34a and minus side wiring 34b between the protective circuit 26 and the energizing terminal 27 connected to external devices in a predetermined condition. The predetermined condition means, for example, the case where the temperature detected by the thermistor 25 is a predetermined one or higher. Also, the predetermined condition means, for example, the case of detecting overcharge, overdischarge and over-current of the unit cell 21. The detections of this overcharge and the like are made for individual unit cells 21 or whole unit cells 21. When individual unit cells 21 are detected, either the voltage of the battery may be detected or the potential of the positive electrode or negative electrode may be detected. In the latter case, a lithium electrode used as a reference electrode is inserted between individual unit cells 21. In the case of FIG. 6 and FIG. 7, a wiring 38 for detecting voltage is connected to each unit cell 21 and the detected signals are transmitted to the protective circuit 26 through these wirings 38.

The battery comprised in the battery pack of this embodiment is excellent in control of the potential of the positive electrode or the negative electrode by the cell voltage detection. Thus, a protective circuit which detects a cell voltage is preferably used.

A protective sheet 35 made of a rubber or resin is disposed on each of the three side surfaces of the battery module 23 excluding the side surface from which the positive electrode terminal 18 and negative electrode terminal 19 are projected.

The battery module 23 is accommodated in a container 36 together with each protective sheet 35 and printed wiring board 24. Specifically, the protective sheet 35 is disposed on each inside surface in the direction of the long side and on one of the inside surfaces in the direction of the short side of the container 36, and the printed wiring board 24 is disposed on the other inside surface in the direction of the short side. The battery module 23 is positioned in a space enclosed by the protective sheet 35 and the printed wiring board 24. A lid 37 is attached to the upper surface of the container 36.

Here, a thermally contracting tape may be used in place of the adhesive tape 22 to secure the battery module 23. In this case, after the protective sheet is disposed on both sides of the battery module and the thermally contracting tubes are wound around the battery module; the thermally contracting tape is contracted by heating to fasten the battery module.

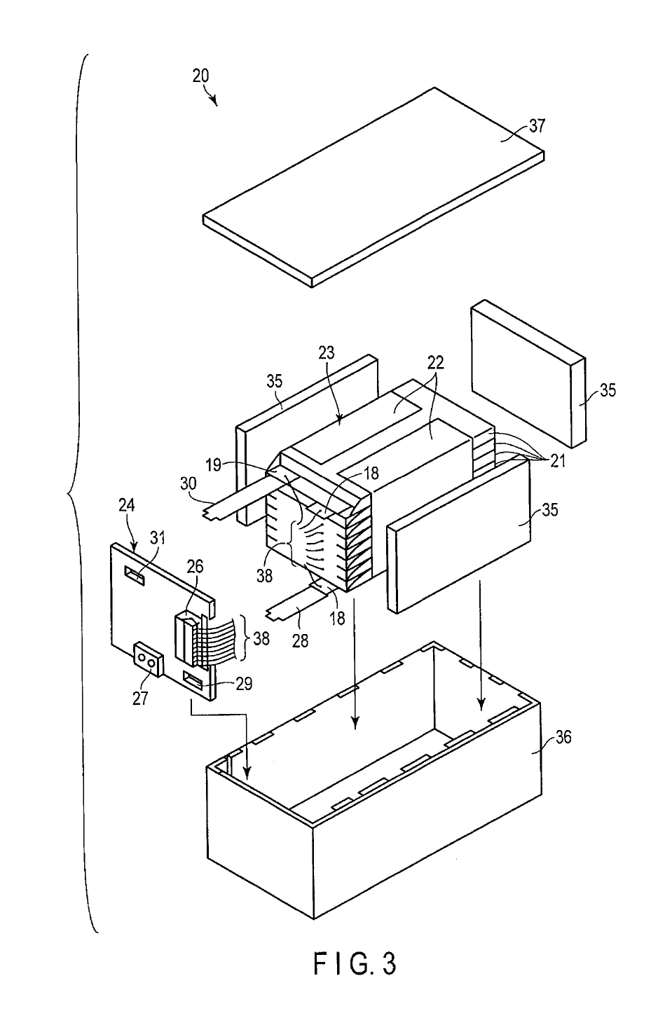

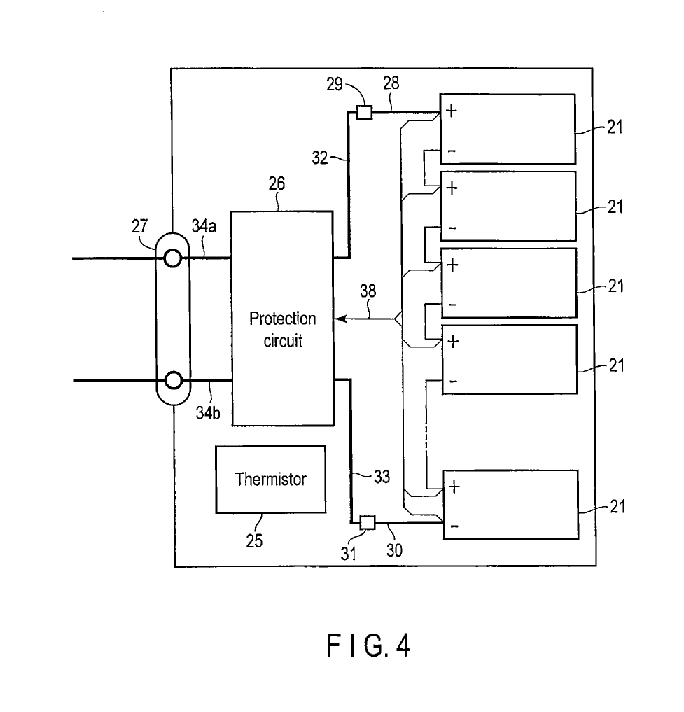

The structure in which the unit cells 21 are connected in series is shown in FIG. 3 and FIG. 4. However, these unit cells may be connected in parallel to increase the capacity of the battery. The assembled battery packs may be further connected in series or in parallel.

According to the above embodiment, a battery pack improved in a cycle life can be provided by using a nonaqueous electrolyte battery having an excellent cycle life. A battery pack preferably used for vehicles can be provided by using a nonaqueous electrolyte battery superior in low-temperature characteristics as described in the third embodiment.

### EXAMPLES

### Example 1

### <Synthesis of Titanate Oxide Compound Having TiO₂(B) Structure>

Potassium carbonate (K₂CO₃) and titanium oxide having anatase structure (TiO₂) were used as starting materials. These starting materials were mixed and sintered at 1000° C. for 24 hours to synthesize a potassium titanate oxide compound (K₂Ti₄O₉). This potassium titanate oxide compound was dry-milled using zirconia beads to regulate its grain size and then, washed with distilled water to obtain a proton-exchange precursor. This proton-exchange precursor was added to a 1 M hydrochloric acid solution, which was then ultrasonically stirred at 25° C. for 1 hour. This operation was repeated 12 times while exchanging the hydrochloric acid solution. After the acid treatment was finished, the precursor was washed with distilled water to obtain a proton-exchanged compound. This proton-exchanged compound was sintered in air at 350° C. for 3 hours to obtain a titanate oxide compound (TiO₂) having TiO₂(B) structure.

### <Production of Negative Electrode Active Material>

7 g of tetraethoxysilane and 10 g of purified water were added to 15 g of the titanate oxide compound synthesized as described above, and they were subjected to a drying treatment in an ambient temperature environment (25° C., RH50%). The mass of the titanate oxide compound after the drying was confirmed to be increased by 15% based on the mass of the initial titanate oxide compound. Then, further drying treatment was carried out in an air atmosphere at 200° C. for 1 hour, and the mass of the titanate oxide compound was confirmed to be increased by 8% after a series of treatments. When the surface of the particles was observed by SEM, a Si oxide layer was confirmed to be formed on the surface of titanium oxide. The titanate oxide compound having the layer was used as the negative electrode active material.

### <Production of Negative Electrode>

90% by mass of the negative electrode active material, 5% by mass of acetylene black, and 5% by mass of polyvinylidene fluoride (PVdF) were added to NMP and mixed to prepare a slurry. This slurry was applied to both surfaces of a current collector made of an aluminum foil having the thickness of 15 μm and dried, followed by pressing to produce a negative electrode having an electrode density of 2.0 g/cm³.

### <Production of Positive Electrode>

A lithium-nickel complex oxide

(LiNi_{0.82}Co_{0.15}A_{0.03}O₂) was used as the positive electrode active material, and acetylene black and polyvinylidene fluoride (PVdF) were used as the conductive agents. 90% by mass of the lithium-nickel complex oxide, 5% by mass of acetylene black, and 5% by mass of polyvinylidene fluoride (PVdF) were added to and mixed with NMP to prepare a slurry. This slurry was applied to both surfaces of a current collector made of an aluminum foil having the thickness of 15 μm and dried, followed by pressing to produce a positive electrode having an electrode density of 3.15 g/cm³.

### <Production of Electrode Group>

The positive electrode, a separator made of a polyethylene porous film having the thickness of 25 μm, the negative electrode and a separator were laminated in this order and spirally coiled. This coiled laminate was pressed under heating at 90° C. to produce a flat type electrode group having a width of 30 mm and a thickness of 3.0 mm. The obtained electrode group was accommodated in a pack made of a laminate film, which was then dried under vacuum at 80° C. for 24 hours. The laminate film had a structure in which polypropylene layers were formed on both side of an aluminum foil having the thickness of 40 μm. The whole thickness of the laminate was 0.1 mm.

### <Preparation of Liquid Nonaqueous Electrolyte>

Ethylene carbonate (EC) and ethylmethyl carbonate (EMC) were mixed in a ratio by volume of 1:2 to prepare a mixed solvent. 1 M of LiPF₆ was dissolved as an electrolyte in this mixed solvent to prepare a liquid nonaqueous electrolyte.

### <Producing of Nonaqueous Electrolyte Secondary Battery>

The liquid nonaqueous electrolyte was injected to a laminate film pack with an electrode group put therein. After that, the pack was perfectly sealed by heat sealing to produce a nonaqueous electrolyte secondary battery which had a structure as shown in FIG. 1 and a width of 35 mm, a thickness of 3.2 mm and a height of 65 mm.

### Example 2

### <Synthesis of Titanate Oxide Compound Containing Nb and Having TiO₂(B) Structure>

Potassium carbonate (K₂CO₃), titanium oxide having anatase structure (TiO₂), and niobium hydroxide (Nb₂O₅.nH₂O) were used as starting materials. These starting materials were mixed and sintered at 1000° C. for 24 hours to synthesize an alkali titanate oxide compound (K—Ti—Nb—O compound) containing Nb. This K—Ti—Nb—O compound was dry-milled using zirconia beads to regulate its grain size and then, washed with distilled water to obtain a proton-exchange precursor. This proton-exchange precursor was added to a 1 M hydrochloric acid solution, which was then ultrasonically stirred at 25° C. for 1 hour. This operation was repeated 12 times while exchanging the hydrochloric acid solution. After the acid treatment was finished, washed with distilled water to obtain a proton-exchanged compound containing Nb. This proton-exchanged compound containing Nb was sintered in air at 350° C. for 3 hours to obtain a titanate oxide compound containing Nb and having TiO₂(B) structure.

The obtained titanate oxide compound was measured by ICP emission spectral analysis. As a result, the content of Nb was 8% by mass based on the total mass of the titanate oxide compound containing Nb.

### <Production of Negative Electrode Active Material>

7 g of tetraethoxysilane and 10 g of purified water were added to 15 g of the titanate oxide compound containing Nb and having TiO₂(B) structure synthesized as described above, and a drying treatment was carried out in an ambient temperature environment (25° C., RH50%). The mass of the titanate oxide compound after drying was confirmed to be increased by 15% based on the mass of the initial titanate oxide compound. Then, a drying treatment was carried out in an air atmosphere at 200° C. for 1 hour, and the mass of the titanate oxide compound was confirmed to be increased by 8% after a series of treatments. When the surface of the particles was observed by SEM, a Si oxide layer was confirmed to be formed on the surface of the titanate oxide compound containing Nb and having TiO₂(B) structure. The titanate oxide compound having the layer was used as the negative electrode active material.

### <Production of Nonaqueous Electrolyte Secondary Battery>

A nonaqueous electrolyte secondary battery was produced in the same manner as in Example 1 using the above negative electrode active material.

### Example 3

15 g of tetraethoxysilane and 5 g of purified water were added to 15 g of the titanate oxide compound synthesized in Example 2 and a drying treatment was carried out in an ambient temperature environment (25° C., RH50%). The mass of the dried titanate oxide compound was confirmed to be increased by 20% based on the mass of the initial titanate oxide compound. Then, a drying treatment was further carried out in an air atmosphere at 200° C. for 1 hour, and the mass of the titanate oxide compound was confirmed to be increased by about 15% after a series of treatments. When the surface was observed by SEM, an oxide layer primarily containing Si was confirmed to be present on the surface of the titanate oxide compound containing Nb and having TiO₂(B) structure. The titanate oxide compound having the layer was used as the negative electrode active material.

A nonaqueous electrolyte battery was produced in the same manner as in Example 1 using the negative electrode active material obtained as described above.

### Example 4

4 g of tetraethoxysilane and 5 g of purified water were added to 15 g of the titanate oxide compound synthesized in Example 2, and a drying treatment was carried out in an ambient temperature environment (25° C., RH50%). The mass of the dried titanate oxide compound was confirmed to be increased by 7% based on the mass of the initial titanate oxide compound. Then, a drying treatment was further carried out in an air atmosphere at 200° C. for 1 hour, and the mass of the titanate oxide compound was confirmed to be increased by about 5% after a series of treatments. When the surface was observed by SEM, an oxide layer primarily containing Si was confirmed to be present on the surface of the titanate oxide compound containing Nb and having TiO₂(B) structure. The titanate oxide compound having the layer was used as the negative electrode active material.

A nonaqueous electrolyte battery was produced in the same manner as in Example 1 using the negative electrode active material obtained as described above.

### Example 5

A nonaqueous electrolyte battery was produced in the same manner as in Example 2 except that 15 g of tetraethoxysilane and 10 g of purified water were added to 15 g of the titanate oxide compound synthesized in Example 2.

### Example 6

1M sodium hydroxide aqueous solution was dripped into 30 mL of a 1 M aluminum nitrate aqueous solution while the aqueous solutions were stirred with a stirrer to produce an aluminium hydroxide precipitate. Then, 15 g of the titanate oxide compound synthesized as described in Example 2 was added and stirred. After that, a solid was separated from the solution, and the solid was washed. Then, the solid was dried at ambient temperature. Then, a heat treatment was carried out in an air atmosphere at 250° C. for 2 hours. When the surface was observed by SEM, an aluminum oxide layer was confirmed to be present on the surface of the titanate oxide compound containing Nb and having TiO₂(B) structure. Aluminum oxide contained in an amount of about 10% based on the total mass of the titanate oxide compound was measured by ICP emission analysis. A nonaqueous electrolyte battery was produced in the same manner as in Example 1 using this as a negative electrode active material.

### Example 7

A negative electrode active material having an aluminum layer was produced in the same manner as in Example 6 except that 10 mL of 1M aluminum nitrate aqueous solution was used. Aluminum oxide covered on the surface and contained in an amount of about 3% based on the total mass of the titanate oxide compound containing Nb was measured. A nonaqueous electrolyte battery was produced in the same manner as in Example 1 using this as a negative electrode active material.

### Example 8

A negative electrode active material was produced in the same manner as in Example 6 except that 40 mL of 1M magnesium nitrate aqueous solution was used. In the obtained negative electrode active material, a magnesium oxide layer was confirmed to be formed on the surface of titanium oxide. Magnesium oxide covered on the surface and contained in an amount of about 10% based on the total mass of the titanate oxide compound containing Nb was measured. A nonaqueous electrolyte battery was produced in the same manner as in Example 1 using this as a negative electrode active material.

### Example 9

A negative electrode active material was produced in the same manner as in Example 6 except that 12 mL of 1M aluminum nitrate aqueous solution was used. Aluminum oxide covered on the surface and contained in an amount of about 3% based on the total mass of the titanate oxide compound containing Nb was measured. A nonaqueous electrolyte battery was produced in the same manner as in Example 1 using this as a negative electrode active material.

### Example 10

A negative electrode active material was produced in the same manner as in Example 2 except that 30 g of tetraethoxysilane and 10 g of purified water were added to 15 g of the titanate oxide compound synthesized in Example 2.

### Comparative Example 1

A nonaqueous electrolyte battery was produced in the same manner as in Example 1 using the titanate oxide compound synthesized in Example 2 as a negative electrode active material.

### Comparative Example 2

The titanate oxide compound synthesized in Example 1 was dipped in a titanium isopropoxide solution having a concentration of 10% by mass and the pressure was reduced. Then, the titanate oxide compound was taken out by filtration, and the titanate oxide compound was then subjected to a heat treatment at 600° C. for 1 hour to obtain a titanate oxide compound with an additional titanate oxide compound adhered on the surface. A nonaqueous electrolyte battery was produced in the same manner as in Example 1 using this as a negative electrode active material.

### Comparative Example 3

A nonaqueous electrolyte battery was produced in the same manner as in Example 2 except that 1 g of tetraethoxysilane and 3 g of purified water were added to 15 g of the titanate oxide compound synthesized in Example 2.

### (Measurement of Diffusion Reflective Infrared Spectrum)

The negative electrode active materials according to Examples 1 to 10 and Comparative Examples 1 to 3 were subjected to a diffusion reflective spectral method using infrared rays to obtain IR spectra.

First, an active material to be measured was put in a sample cup, which was then set to a cell of diffusion reflectometer. The inside of the cell was heated to 500° C. and kept at that temperature for 1 hour while flowing nitrogen gas at a rate of 50 mL/min. After that, the temperature was dropped to ambient temperature and then raised again to 100° C. Then, the pressure in the cell in which the sample cup was placed was reduced, and then pyridine vapor was introduced into the cell and adsorbed for 30 minutes.

Then, the temperature of the inside of the cell was kept at 100° C. for 1 hour while flowing nitrogen gas at a rate of 100 mL/min and after that, the temperature was raised to 150° C. and kept for 1 hour. Pyridine which was physically adsorbed to or hydrogen-bonded with the active material was released by this treatment. After that, the IR spectrum of the sample was measured.

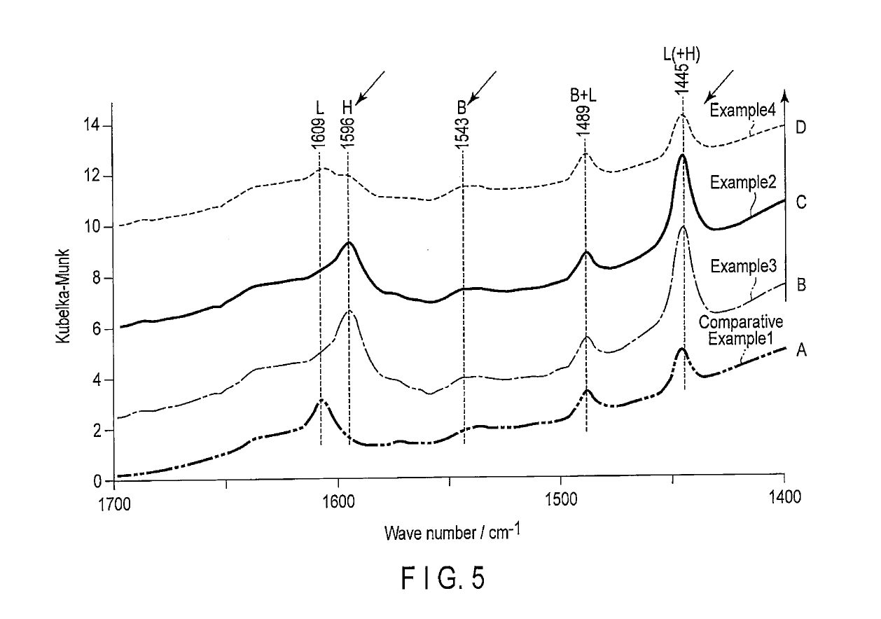

The IR spectra of Examples 2 to 4 and Comparative Example 1 are shown in FIG. 5.

In the IR spectra of Examples 2 to 4, a peak P₃ showing presence of hydrogen bonding was observed at 1596 cm⁻¹. In the meantime, in the IR spectrum of Comparative Example 1, a peak showing hydrogen bonding was not observed at 1596 cm⁻¹. The IR spectra of Examples 2 to 4 showed that the intensity of a peak P₁ appearing in a range of 1430 cm⁻¹ to 1460 cm⁻¹ is greater than that of Comparative Example 1.

This showed that the negative electrode active material having a layer containing Si had a peak P₃ appearing in a range of 1580 cm⁻¹ to 1610 cm⁻¹ and had an increased S₁/S₂ value.

Similarly, Examples 6 to 9 using aluminium hydroxide and magnesium hydroxide in order to form a metal oxide layer had a peak P₃ appearing in a range of 1580 cm⁻¹ to 1610 cm⁻¹ and had an increased S₁/S₂ value.

### (Charge-Discharge Cycle Test)

Using each of the nonaqueous electrolyte secondary batteries according to Examples 1 to 10 and Comparative Examples 1 to 3, a charge-discharge cycle test was carried out to measure a capacity maintenance ratio and a resistance increase ratio.

The charge-discharge operation was carried out at 1 C rate in the environment of 45° C. In the charge operation, constant-current and constant-voltage charge operations were carried out at 1.4 V and the charging time was set to 3 hours. The discharge cutoff voltage was set to 3.0 V to carry out constant-current discharge operations. A charge-discharge operation was repeated 50 cycles (charge operation and discharge operation=one cycle) to measure an initial capacity, a capacity after 50 cycles, resistance of the battery before initial charge-discharge operation, and resistance of the battery after 50 cycles.

An initial capacity of each of Examples and Comparative Examples was represented by a ratio (%) based on the initial capacity of Example 1 when an initial capacity of Example 1 was set to 100. A capacity maintenance ratio (%) after 50 cycles was calculated from the capacity after 50 cycles based on the initial capacity of each of Examples and Comparative Examples. The resistance (R₀) of the battery before an initial charge-discharge operation was set to 1.0, and a resistance increase ratio R₅₀/R₀ after 50 cycles (%) was calculated from battery resistance (R₅₀) after 50 cycles.

The S₁/S₂ of each of the batteries, presence or absence of the peak P₃, an initial capacity ratio (%), a capacity maintenance ratio (%), and a resistance increase ratio R₅₀/R₀ (%) are shown in Table 1.

TABLE 1

| | | | Initial | Capacity | Resistance |
|---|---|---|---|---|---|
| | | | capacity | maintenance | increase |
| | | Presence or | ratio | ratio | ratio |
| | S₁/S₂ | absence of P₃ | (%) | (%) | (%) |
| Example 1 | 2.6 | Presence | 100 | 92 | 136 |
| Example 2 | 2.5 | Presence | 100 | 94 | 128 |
| Example 3 | 2.8 | Presence | 98 | 96 | 115 |
| Example 4 | 2.4 | Presence | 105 | 90 | 150 |
| Example 5 | 2.7 | Presence | 97 | 97 | 121 |
| Example 6 | 2.6 | Presence | 96 | 94 | 110 |
| Example 7 | 2.43 | Presence | 103 | 90 | 124 |
| Example 8 | 2.7 | Presence | 97 | 93 | 115 |
| Example 9 | 2.44 | Presence | 102 | 90 | 138 |
| Example 10 | 2.9 | Presence | 80 | 99 | 101 |
| Comparative | 2.2 | Absence | 108 | 78 | 180 |
| Example 1 | | | | | |
| Comparative | 2.5 | Absence | 115 | 70 | 210 |
| Example 2 | | | | | |
| Comparative | 2.25 | Presence | 110 | 80 | 170 |
| Example 3 | | | | | |

The batteries according to Examples 1 to 10 having an S₁/S₂ of 2.4 or more and a peak P₃ had a higher capacity maintenance ratio and a lower resistance increase ratio than those of the batteries according to Comparative Examples 1 to 3. This showed that the deterioration of the capacity and the increase in the resistance could be limited by using the negative electrode active material having an S₁/S₂ of 2.4 or more and a peak P₃.

It was shown that S₁/S₂ could be set to 2.4 or more even in the layer containing any element of Si, Mg, and Al, and the deterioration of the capacity and the resistance increase ratio could be reduced.

Example 10 had the highest capacity maintenance ratio and the lowest resistance increase ratio. However, the initial capacity was lower. It is considered that the content of the layer in Example 10 was excessive.

Comparative Examples 1 and 2 had a lower capacity maintenance ratio and a higher resistance increase ratio. Comparative Examples 1 and 2 in which the layer was not formed on the surface of the titanate oxide compound showed that the influence of the Lewis acid point was large and the deterioration of the capacity and the increase in the resistance were large.

Comparative Example 2 shows that a peak derived from hydrogen bonding is not present because the peak P₃ is not observed. However, S₁/S₂ was 2.5. Thus, it is considered that the reason why the S₁/S₂ value is high in Comparative Example 2 is because the concentration of the Lewis acid point is higher than that of Comparative Example 1. Actually, Comparative Example 2 had particularly large capacity deterioration and a large increase in resistance.

Although Comparative Example 3 had a Si oxide layer, Comparative Example 3 had an S₁/S₂ of less than 2.4. The capacity maintenance ratio was comparatively low, and the resistance increase ratio was comparatively high. It is considered that the content of the metal oxide layer in Comparative Example 3 was not enough because the influence of the Lewis acid point on the surface of the titanate oxide compound was insufficiently limited.

The titanate oxide compound having TiO₂(B) structure was used as the titanate oxide compound in the above Examples, though the embodiments are not limited to the titanate oxide compound having TiO₂(B) structure. The titanate oxide compound is effective also for one using the titanate oxide compound and titanate composite oxide having a solid acid point and a hydroxyl group on its surface for the negative electrode active material.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An active material comprising a titanate oxide compound,
the active material having a peak appearing in a range of 1580 cm⁻¹ to 1610 cm⁻¹ in the infrared diffusion reflective spectrum when pyridine is absorbed onto the active material and released from it, after that, the active material is subjected to measurement of the infrared diffusion reflective spectrum, and a relationship represented by the following formula (I) being satisfied:
S₁/S₂≧2.4 (I)
wherein S₁ indicates an area of a peak appearing in a range of 1430 cm⁻¹ to 1460 cm⁻¹ in the spectrum, and
S₂ indicates an area of a peak appearing in a range of 1520 cm⁻¹ to 1560 cm⁻¹ in the spectrum.

2. The active material according to claim 1, comprising a metal oxide layer provided on at least a part of a surface of the titanate oxide compound, and the metal oxide comprising at least one element selected from the group consisting of Mg, Al, and Si.

3. The active material according to claim 2, further comprising a metal oxide in a proportion of 1% by mass to 20% by mass based on the mass of the titanate oxide compound.

4. The active material according to claim 1, wherein the titanate oxide compound has a crystal structure of monoclinic titanium dioxide.

5. The active material according to claim 4, wherein the titanate oxide compound contains niobium.

6. The active material according to claim 2, wherein the titanate oxide compound has a crystal structure of monoclinic titanium dioxide.

7. The active material according to claim 6, wherein the titanate oxide compound contains niobium.

8. A nonaqueous electrolyte battery comprising:
a negative electrode comprising the active material according to claim 1;
a positive electrode; and
a nonaqueous electrolyte.

9. A nonaqueous electrolyte battery comprising:
a negative electrode comprising the active material according to claim 2;
a positive electrode; and
a nonaqueous electrolyte.

10. A nonaqueous electrolyte battery comprising:
a negative electrode comprising the active material according to claim 3;
a positive electrode; and
a nonaqueous electrolyte.

11. A nonaqueous electrolyte battery comprising:
a negative electrode comprising the active material according to claim 4;
a positive electrode; and
a nonaqueous electrolyte.

12. A nonaqueous electrolyte battery comprising:
a negative electrode comprising the active material according to claim 5;
a positive electrode; and
a nonaqueous electrolyte.

13. A battery pack comprising:
the nonaqueous electrolyte battery according to claim 8; and
a container accommodating the battery.

14. A battery pack comprising:
the nonaqueous electrolyte battery according to claim 9; and
a container accommodating the battery.

15. A battery pack comprising:
the nonaqueous electrolyte battery according to claim 10; and
a container accommodating the battery.

16. A battery pack comprising:
the nonaqueous electrolyte battery according to claim 11; and
a container accommodating the battery.

17. A battery pack comprising:
the nonaqueous electrolyte battery according to claim 12; and
a container accommodating the battery.

18. A method of producing an active material comprising:
mixing a titanate oxide compound particles with a metal alkoxide containing at least one element selected from Mg, Al and Si and water to obtain a mixture; and
drying the mixture to form a metal oxide layer containing at least one element selected from Mg, Al and Si on at least a part of a surface of the titanate oxide compound particles.

19. A method of producing an active material comprising:
mixing a titanate oxide compound particles with an aqueous solution to obtain a mixture, the solution comprising a compound selected from hydrolyte and collide, the compound containing at least one element selected from Mg, Al and Si;
attaching a metal oxide precursor containing at least one element selected from Mg, Al and Si on at least a part of a surface of the titanate oxide compound particles by adjusting the pH of the mixture;
separating the titanate oxide compound particles attached by the metal oxide precursor from the aqueous solution; and
drying the titanate oxide compound particles to form a metal oxide layer containing at least one element selected from Mg, Al and Si on at least a part of a surface of the titanate oxide compound particles.
